(19) United States
(12) Patent Application Publication
(10) Pub. No.: US 2026/0281542 A1
(43) Pub. Date: Sep. 17, 2026

(54) IMAGE PROCESSING SYSTEM, CONTROL METHOD OF IMAGE PROCESSING SYSTEM, AND PROGRAM

(71) Applicant: FUJIFILM Corporation, Tokyo (JP)

(72) Inventor: Kosuke KURIBAYASHI, Saitama (JP)

(73) Assignee: FUJIFILM Corporation, Tokyo (JP)

(21) Appl. No.: 19/562,779

(22) Filed: Mar. 11, 2026

(30) Foreign Application Priority Data
Mar. 13, 2025 (JP) 2025-040728

(51) Int. Cl. H04N 23/60; G06T 3/4038; G06T 7/33; G06T 7/73; H04N 23/63; H04N 23/68

(52) U.S. Cl. CPC H04N 23/64; G06T 3/4038; G06T 7/337; G06T 7/74; H04N 23/631; H04N 23/683; H04N 23/687; G06T 2207/20216

(57) ABSTRACT

An image processing system includes a processor, in which the processor is configured to acquire a plurality of first-form images in which each pixel is any one of three channels, select one image among the plurality of first-form images as a reference image and one or more other images, each of the one or more other images being a composite target image, convert the reference image and the composite target image from the first-form image to a second-form image, acquire information on a positional relationship between the reference image and the composite target image based on the second-form image, perform registration between the reference image and the composite target image in a first form based on the information on the positional relationship, and output information on imaging control in accordance with a ratio of a pixel region, in which the three channels are aligned, to an entire pixel region.

### CROSS-REFERENCE TO RELATED APPLICATIONS

The present application claims priority under 35 U.S.C. § 119 to Japanese Patent Application No. 2025-040728, filed on Mar. 13, 2025. The above application is hereby expressly incorporated by reference, in its entirety, into the present application.

### BACKGROUND

### 1. Technical Field

The technology of the present disclosure relates to an image processing system, a control method of an image processing system, and a program.

### 2. Description of the Related Art

JP2019-161564A discloses an image processing apparatus capable of obtaining high-quality composite image data. An acquisition unit acquires a plurality of image data having RGB color elements. A division unit divides each image data into a plurality of regions.

A calculation unit calculates a shift amount for each region of each image data. A color interpolation unit performs color interpolation for at least one of RGB color elements based on the shift amount for each region of each image data.

WO2022/264691A discloses an imaging method used in an imaging apparatus including an imaging element that images a subject image and a movement mechanism that can change a relative position between the subject image and the imaging element. The imaging method includes a change step of changing the relative position a plurality of times, an imaging step of acquiring a plurality of first images by imaging the subject image using the imaging element at the plurality of relative positions, a composite step of generating a second image by combining the plurality of first images, and a display step of performing temporal display related to the imaging step or the composite step.

JP2016-025447A discloses an image processing apparatus that performs super-resolution processing of generating one high-resolution image from a plurality of low-resolution images. The image processing apparatus includes a calculation unit that calculates a registration parameter used in a case of performing registration of each of a reference image and a non-reference image, in which one of the plurality of low-resolution images is used as the reference image and the remaining images are used as the non-reference images, a determination unit that determines whether or not each non-reference image is used for super-resolution processing in accordance with the registration parameter, and a generation unit that performs the super-resolution processing using the non-reference image determined to be used for the super-resolution processing by the determination unit and the reference image to generate a high-resolution image.

### SUMMARY

One embodiment according to the technology of the present disclosure provides an image processing system, a control method of an image processing system, and a program that can generate a high-accuracy super-resolution image with low noise in a case of performing continuous imaging while being handheld.

In order to achieve the above object, an image processing system according to the present disclosure includes a processor, in which the processor is configured to acquire a plurality of first-form images in which each pixel is any one of three channels, select one image among the plurality of first-form images as a reference image and one or more other images, each of the one or more other images being a composite target image, convert the reference image and the composite target image from the first-form image to a second-form image, acquire information on a positional relationship between the reference image and the composite target image based on the second-form image, perform registration between the reference image and the composite target image in a first form based on the information on the positional relationship, and output information on imaging control in accordance with a ratio of a pixel region, in which the three channels are aligned, to an entire pixel region.

The processor may be configured to generate a composite image obtained by combining the reference image and the composite target image by using the information on the positional relationship, and output the information on the imaging control in accordance with the ratio.

The imaging control may be control related to determination of a necessary number of sheets for the composite target image.

The imaging control may be control of additionally acquiring the composite target image.

The imaging control may be control of displaying the information in accordance with the ratio on a display device.

The information may be information on the number of sheets to be additionally acquired for the composite target image.

The image processing system according to the present disclosure includes a vibration-proof mechanism, in which the processor is configured to restrict an operation of the vibration-proof mechanism in a case where an imaging element performs an imaging operation.

The first form may be a Raw form, and the second form may be an RGB form.

The processor may be configured to generate a composite image by performing projective transformation on the composite target image using the information on the positional relationship, and then combining the reference image and the composite target image.

The processor may generate a composite image by increasing a resolution of the reference image and the composite target image and then combining the reference image and the composite target image.

The processor may generate the composite image by increasing the resolution of the reference image and the composite target image to a resolution higher than a specific resolution, and may decrease the resolution of the composite image to the specific resolution.

The processor may be configured to determine, when a pixel value of each pixel of the composite image is determined, an average value as the pixel value in a case where a plurality of the same channels are present.

The processor may be configured to determine, when a pixel value of each pixel of the composite image is determined, an interpolated value obtained by using peripheral values as the pixel value in a case where a missing channel is present.

The processor may be configured to calculate the positional relationship and the ratio while an imaging element is allowed to perform continuous imaging, and end the continuous imaging in a case where the ratio reaches a threshold value or more, in a case where the positional relationship is maintained in a constant state, or in a case where a predetermined time is reached.

The processor may acquire a plurality of first-form images in a continuous manner, and may select a first image as the reference image.

The processor may select an image having the highest ratio among the plurality of first-form images as the reference image.

There is provided a control method of an image processing system including a processor according to the present disclosure, the control method comprising: via the processor, acquiring a plurality of first-form images in which each pixel is any one of three channels; selecting one image among the plurality of first-form images as a reference image and one or more other images, each of the one or more other images being a composite target image; converting the reference image and the composite target image from the first-form image to a second-form image; acquiring information on a positional relationship between the reference image and the composite target image based on the second-form image; performing registration between the reference image and the composite target image in a first form based on the information on the positional relationship; and outputting information on imaging control in accordance with a ratio of a pixel region, in which the three channels are aligned, to an entire pixel region.

There is provided a program according to the present disclosure that operates an image processing system including a processor, the program causing the processor to execute a process comprising: acquiring a plurality of first-form images in which each pixel is any one of three channels; selecting one image among the plurality of first-form images as a reference image and one or more other images, each of the one or more other images being a composite target image; converting the reference image and the composite target image from the first-form image to a second-form image; acquiring information on a positional relationship between the reference image and the composite target image based on the second-form image; performing registration between the reference image and the composite target image in a first form based on the information on the positional relationship; and outputting information on imaging control in accordance with a ratio of a pixel region, in which the three channels are aligned, to an entire pixel region.

### BRIEF DESCRIPTION OF THE DRAWINGS

Exemplary embodiments according to the technique of the present disclosure will be described in detail based on the following figures, wherein:

FIG. 1 is a schematic perspective view showing an example of a front surface side of an imaging apparatus,

FIG. 2 is an explanatory diagram showing an example of an internal configuration of the imaging apparatus,

FIG. 3 is an explanatory diagram showing an example of a pixel arrangement on a light-receiving surface of the imaging element,

FIG. 4 is a block diagram showing a functional configuration of a processor in a camera shake-utilizing multi-shot composite mode,

FIG. 5 is a diagram showing a flow of an image selection process by an imaging controller,

FIG. 6 is a diagram showing an image conversion process by an image format conversion unit,

FIG. 7 is a diagram showing a concept of extraction of a feature point and projective transformation by a positional relationship information acquisition unit,

FIG. 8 is a diagram showing a method of performing registration of the reference image and the composite target image,

FIG. 9 is a diagram specifically showing the registration of the reference image and the composite target image,

FIG. 10 is a diagram showing a calculation method of a channel sufficiency ratio,

FIG. 11 is a diagram showing the calculation method of the channel sufficiency ratio,

FIG. 12 is a diagram showing an interpolation process,

FIG. 13 is a flowchart showing a processing flow in the camera shake-utilizing multi-shot composite mode,

FIG. 14 is a diagram showing a display example of information in accordance with the channel sufficiency ratio,

FIG. 15 is a diagram showing a process of combining the images after increasing the resolution,

FIG. 16 is a diagram showing a modification example of the composite image processing, and

FIG. 17 is a diagram showing a configuration of a system in which the imaging apparatus and an external apparatus are connected to each other.

### DETAILED DESCRIPTION

An example of an embodiment according to the technology of the present disclosure will be described with reference to the accompanying drawings.

The terms used in the following description will be described first.

In the following description, “IC” is an abbreviation for “integrated circuit”. The “CPU” is an abbreviation for “central processing unit”. The “ROM” is an abbreviation for “read only memory”. The “RAM” is an abbreviation for “random access memory”. “CMOS” is an abbreviation for “complementary metal oxide semiconductor”.

The “FPGA” is an abbreviation for “field programmable gate array”. The “ASIC” is an abbreviation for “application specific integrated circuit”. The “OVF” is an abbreviation for “optical view finder”. The “EVF” is an abbreviation for “electronic view finder”.

As one embodiment of an imaging apparatus, the technology of the present disclosure will be described by using a lens-interchangeable digital camera as an example. Note that the technology of the present disclosure is not limited to the lens-interchangeable type and can also be applied to a lens-integrated digital camera.

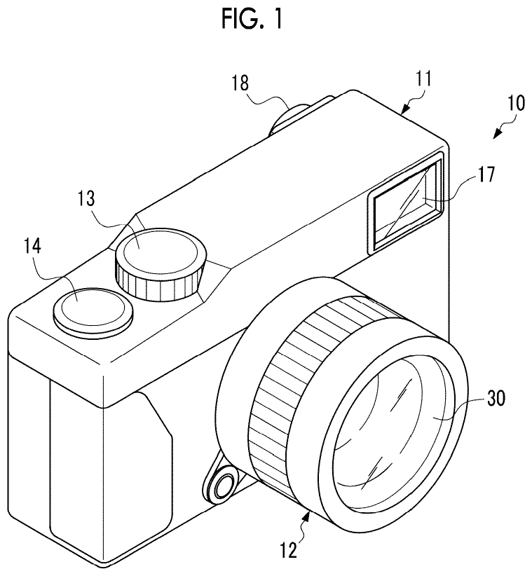

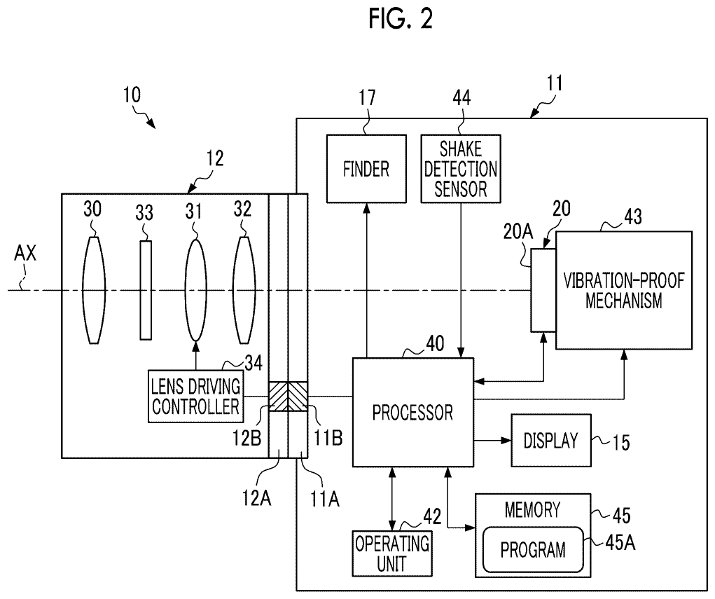

FIG. 1 shows an example of a front surface side of an imaging apparatus 10. As shown in FIG. 1, the imaging apparatus 10 is a lens-interchangeable digital camera. The imaging apparatus 10 includes a main body 11 and an imaging lens 12 which is interchangeably mounted on the main body 11. The imaging lens 12 is attached to a front surface side of the main body 11 via a camera-side mount 11A and a lens-side mount 12A (refer to FIG. 2). The imaging apparatus 10 is an example of an “image processing system” according to the technology of the present disclosure.

A dial 13 and a release button 14 are provided on an upper surface of the main body 11. The dial 13 is operated in a case of setting an operation mode or the like. Examples of the operation mode of the imaging apparatus 10 include a still image capturing mode, a video image capturing mode, and an image display mode. The release button 14 is operated by a user in a case of starting execution of the still image capturing or the video image capturing.

In addition, the still image capturing mode includes a “camera shake-utilizing multi-shot composite mode” for generating a super-resolution image. The camera shake-utilizing multi-shot composite mode in the present embodiment is a mode of acquiring a plurality of images and combining the images by using a shake that occurs in the imaging apparatus 10 due to a camera shake of the user or the like during the continuous imaging, on the premise that a relative position between the subject image and an imaging element 20 (see FIG. 2) is changed. With this method, it is possible to generate a super-resolution image having a resolution higher than a resolution of a single image by combining a plurality of images captured at different relative positions. That is, the camera shake-utilizing multi-shot composite mode uses a slight deviation during the handheld imaging and integrates sub-pixel information of each image to realize higher resolution and reproduction of details.

The main body 11 is provided with a finder 17. Here, the finder 17 is a hybrid finder (registered trademark). The hybrid finder refers to a finder in which, for example, an optical view finder (hereinafter, referred to as “OVF”) and an electronic view finder (hereinafter, referred to as “EVF”) are selectively used.

A finder eyepiece portion 18 is provided on a back surface side of the main body 11. An optical image that can be visually recognized by the OVF and a live view image that is an electronic image that can be visually recognized by the EVF are selectively projected on the finder eyepiece portion 18. The user can observe an optical image or a live view image of a subject via the finder eyepiece portion 18.

In addition, a display 15 (see FIG. 2) is provided on the back surface side of the main body 11. An image based on an image signal obtained by the imaging, various menu screens, messages, and the like are displayed on the display 15. The display 15 is an example of a “display device” according to the technology of the present disclosure.

FIG. 2 shows an example of an internal configuration of the imaging apparatus 10. The main body 11 and the imaging lens 12 are electrically connected to each other by bringing an electrical contact 11B provided on a camera-side mount 11A into contact with an electrical contact 12B provided on a lens-side mount 12A.

The imaging lens 12 includes an objective lens 30, a focus lens 31, a rear end lens 32, and a stop 33. Each member is disposed in the order of the objective lens 30, the stop 33, the focus lens 31, and the rear end lens 32 from the objective side along an optical axis AX of the imaging lens 12. The objective lens 30, the focus lens 31, and the rear end lens 32 constitute an imaging optical system. The type, number, and arrangement order of the lenses constituting the imaging optical system are not limited to the example shown in FIG. 2.

In addition, the imaging lens 12 includes a lens driving controller 34. The lens driving controller 34 is formed of, for example, a CPU, a RAM, or a ROM. The lens driving controller 34 is electrically connected to a processor 40 in the main body 11 via the electrical contact 12B and the electrical contact 11B.

The lens driving controller 34 drives the focus lens 31 and the stop 33 based on a control signal transmitted from the processor 40. The lens driving controller 34 performs drive control of the focus lens 31 based on a control signal for focusing control transmitted from the processor 40 in order to adjust a focal position of the imaging lens 12.

The stop 33 has an opening in which an opening diameter is variable with the optical axis AX as a center. The lens driving controller 34 performs drive control of the stop 33 based on a control signal for stop adjustment transmitted from the processor 40 in order to adjust the amount of light incident on a light-receiving surface 20A of the imaging element 20.

The main body 11 is provided with the imaging element 20, the processor 40, an operating unit 42, a vibration-proof mechanism 43, a shake detection sensor 44, a memory 45, and the display 15. The operation of the imaging element 20, the operating unit 42, the vibration-proof mechanism 43, the shake detection sensor 44, the memory 45, and the display 15 is controlled by the processor 40.

The processor 40 includes, for example, a CPU, a RAM, and a ROM. In such a case, the processor 40 executes various kinds of processing on the basis of a program 45A stored in the memory 45. The processor 40 may be formed of an aggregate of a plurality of IC chips.

The imaging element 20 is, for example, a CMOS image sensor. The imaging element 20 is disposed such that the optical axis AX is orthogonal to the light-receiving surface 20A. Light (subject image) that has passed through the imaging lens 12 is incident on the light-receiving surface 20A. A plurality of pixels, which generate an image signal by performing photoelectric conversion, are formed on the light-receiving surface 20A. The imaging element 20 generates and outputs an image signal by performing photoelectric conversion on the light incident on each pixel.

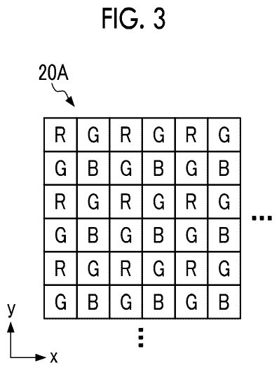

In addition, as shown in FIG. 3, a plurality of pixels are arranged in the x direction and the y direction on the light-receiving surface 20A of the imaging element 20. Specifically, a color filter array of a Bayer array is disposed on the light-receiving surface 20A, and any one of a red (R) color filter, a green (G) color filter, or a blue (B) color filter is disposed to face each pixel. In the image processing, a unit for separating and processing these different color components is referred to as a “channel”. In the present embodiment, there are three channels of the R channel, the G channel, and the B channel, and each of the channels is responsible for the R, G, and B components.

The Bayer array is a color array in which the G channel is assigned to two pixels on a diagonal in four pixels of 2×2, and the R channel and the B channel are assigned to the remaining two pixels, respectively. In FIG. 3, “R” represents a pixel of the R channel, “G” represents a pixel of the G channel, and “B” represents a pixel of the B channel. The arrangement of the color filter array is not limited to the Bayer array, and can be changed as appropriate.

The image output from the imaging element 20 is a Raw image. The Raw image is an example of a “first-form image” in which each pixel is any one of three channels.

In addition, the imaging element 20 is held by the vibration-proof mechanism 43. The vibration-proof mechanism 43 holds the imaging element 20 to be translatable in a direction orthogonal to the optical axis AX and rotatable in a roll direction. The vibration-proof mechanism 43 may be a mechanism that drives a part of lenses constituting the imaging optical system of the imaging lens 12 to change the relative position between the subject image and the imaging element 20.

The shake detection sensor 44 detects a shake applied to the main body 11 that accommodates the imaging element 20. The shake detection sensor 44 is formed of, for example, a gyro sensor and an acceleration sensor. The processor 40 performs drive control of the vibration-proof mechanism 43 based on shake information of the imaging apparatus 10 detected by the shake detection sensor 44. Specifically, the processor 40 changes the relative position between the subject image and the imaging element 20 to cancel the displacement of the subject image due to the camera shake of the user.

In a case where the camera shake-utilizing multi-shot composite mode is executed, the processor 40 restricts the operation of the vibration-proof mechanism 43. For example, in a case where the camera shake-utilizing multi-shot composite mode is executed, the processor 40 stops the operation of the vibration-proof mechanism 43.

A position detection sensor for detecting a position of the imaging element 20 may be provided in the vibration-proof mechanism 43. This position detection sensor is, for example, a hall sensor. In this case, the processor 40 performs drive control of the vibration-proof mechanism 43 based on shake information detected by the shake detection sensor 44 and position information of the imaging element 20 detected by the position detection sensor.

In a case of the camera shake-utilizing multi-shot composite mode, the processor 40 causes the imaging element 20 to perform the continuous imaging (that is, a plurality of imaging operations) in response to the operation of the release button 14 by the user. That is, in the camera shake-utilizing multi-shot composite mode, the imaging element 20 performs imaging processing of generating and outputting a plurality of Raw images in which the relative position between the subject image and the imaging element 20 is different.

The processor 40 generates a super-resolution image by combining the plurality of Raw images after performing the registration. Details will be described below.

The display 15 displays an image based on the image data generated by the processor 40. The image includes a still image, a video, and a live view image. The live view image is an image that is displayed in real time on the display 15 by sequentially outputting the image data to the display 15.

The image data generated by the processor 40 can be stored in an internal memory (not shown) built in the main body 11 or a storage medium (for example, a memory card) attachable to and detachable from the main body 11.

The operating unit 42 includes the above-described dial 13 and release button 14, and an instruction key (not shown). The instruction key is provided on the back surface side of the main body 11, for example. The processor 40 controls each unit in the main body 11 and the lens driving controller 34 in the imaging lens 12 in response to an operation of the operating unit 42.

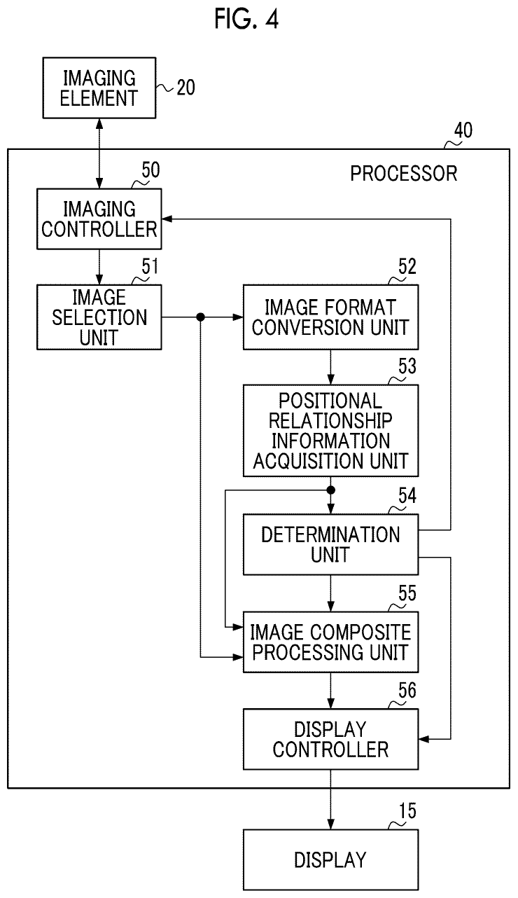

FIG. 4 shows an example of a functional configuration of the processor 40 in the camera shake-utilizing multi-shot composite mode. The processor 40 implements various functional units by executing processing in accordance with the program 45A stored in the memory 45. As shown in FIG. 4, for example, an imaging controller 50, an image selection unit 51, an image format conversion unit 52, a positional relationship information acquisition unit 53, a determination unit 54, an image composite processing unit 55, and a display controller 56 are implemented in the processor 40.

The imaging controller 50 causes the imaging element 20 to perform the imaging operation in response to an imaging instruction signal input from the operating unit 42. The imaging controller 50 causes the imaging element 20 to repeatedly execute the imaging operation a predetermined number of times in response to a determination result of the determination unit 54. Details will be described below. As a result, the imaging element 20 generates and sequentially outputs a plurality of Raw images D0.

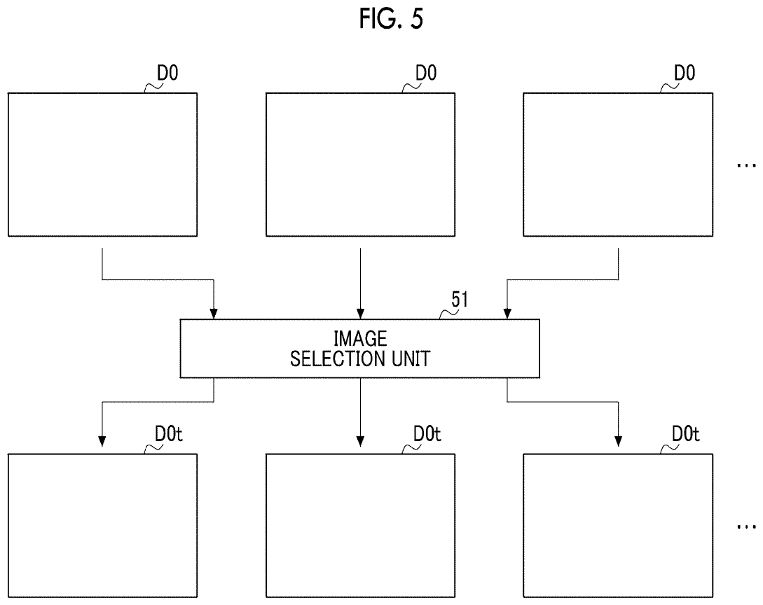

As shown in FIG. 5, the image selection unit 51 selects one of the plurality of Raw images D0 continuously acquired from the imaging element 20 by the imaging controller 50 as a reference image D0r, and selects the others as composite target images D0t. In the present embodiment, the imaging element 20 starts the imaging operation, and the imaging controller 50 selects the Raw image D0 acquired first as the reference image D0r, and selects the Raw image D0 acquired thereafter as the composite target image D0t.

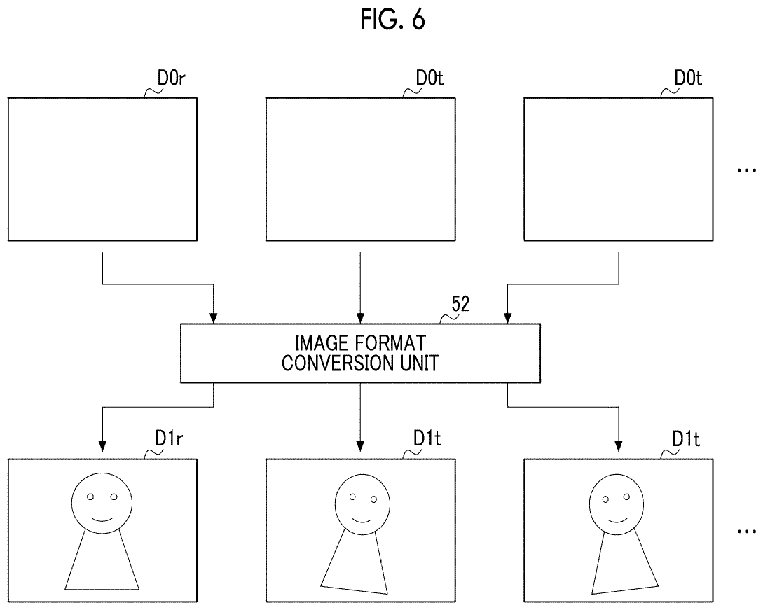

As shown in FIG. 6, the image format conversion unit 52 converts the reference image D0r and the composite target image D0t in the Raw form into images D1r and D1t in the RGB form. The image format conversion unit 52 converts the Raw form into the RGB form by synchronization processing including so-called demosaicing processing. The images D1r and D1t in the RGB form include three channels of R, G, and B in each pixel. By converting the Raw form into the RGB form, it is possible to recognize the feature of the subject image from the image. The Raw form is an example of a “first form” according to the technology of the present disclosure. The RGB form is an example of a “second form” according to the technology of the present disclosure. The second form is not limited to the RGB form, and may be a grayscale form or a monochrome form in which each pixel is represented by a brightness value.

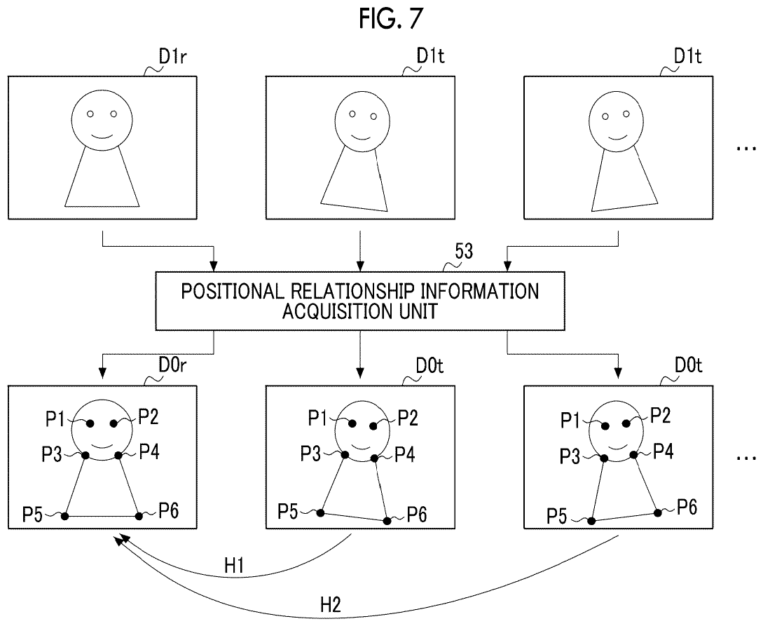

As shown in FIG. 7, the positional relationship information acquisition unit 53 acquires information (hereinafter, referred to as positional relationship information) on the positional relationship between the reference image D0r and the composite target image D0t based on the images D1r and D1t in the RGB form. Specifically, the positional relationship information acquisition unit 53 extracts a feature point of the subject image from each of the images D1r and D1t, and obtains a projective transformation matrix H for transforming each feature point in the image D1t into a corresponding feature point in the image D1r. The projective transformation matrix H is a transformation matrix for correcting a geometric deviation (translation, rotation, scaling, distortion, and the like) of the image, and transforms the subject image of the composite target image D0t to match the subject image of the reference image D0r.

In the example shown in FIG. 7, six feature points P1 to P6 are extracted from the subject images of the images D1r and D1t. The projective transformation matrix H1 is positional relationship information between the first composite target image D0t acquired after the reference image D0r and the reference image D0r. The projective transformation matrix H2 is positional relationship information between the second composite target image D0t and the reference image D0r.

The determination unit 54 calculates a ratio RT (hereinafter, referred to as a channel sufficiency ratio RT) of a pixel region in which the three channels are aligned with respect to the entire pixel region in a case where the reference image D0r and the composite target image D0t are subjected to registration using the positional relationship information acquired by the positional relationship information acquisition unit 53. In addition, the determination unit 54 outputs information on the imaging control in accordance with the calculated channel sufficiency ratio RT. In the present embodiment, the imaging control in accordance with the channel sufficiency ratio RT is control of acquiring the composite target image D0t additionally.

Specifically, in a case where the channel sufficiency ratio RT is smaller than a threshold value Rth, the determination unit 54 issues an instruction to the imaging controller 50 to cause the imaging element 20 to perform the imaging operation. The Raw image generated by the imaging operation is selected as the composite target image D0t by the image selection unit 51. The composite target image D0t additionally acquired is converted into an image D1t in the RGB form by the image format conversion unit 52. Further, the positional relationship information acquisition unit 53 acquires the positional relationship information between the reference image D0r and the composite target image D0t.

In addition, the determination unit 54 issues an instruction to the display controller 56 to display information in accordance with the channel sufficiency ratio RT on the display 15. For example, the information in accordance with the channel sufficiency ratio RT is the number of sheets of the composite target image D0t to be additionally acquired in order to reach the threshold value Rth of the channel sufficiency ratio RT.

In addition, the determination unit 54 determines whether or not there is an error on the positional relationship between the reference image D0r and the composite target image D0t, and ends the imaging operation without acquiring the composite target image D0t additionally in a case where the error is present. In this case, the determination unit 54 issues an instruction to the display controller 56 to display an error message indicating that an error has occurred in the process on the display 15.

In a case where the channel sufficiency ratio RT is equal to or larger than the threshold value Rth, the determination unit 54 issues an instruction to the display controller 56 to display a success message indicating that the process has been successful on the display 15, and causes the image composite processing unit 55 to generate a composite image. The image composite processing unit 55 generates a composite image by combining the reference image D0r and one or more composite target images D0t that are subjected to registration with the reference image D0r. The composite image is the super-resolution image described above.

The image composite processing unit 55 issues an instruction to the display controller 56 to display the super-resolution image on the display 15.

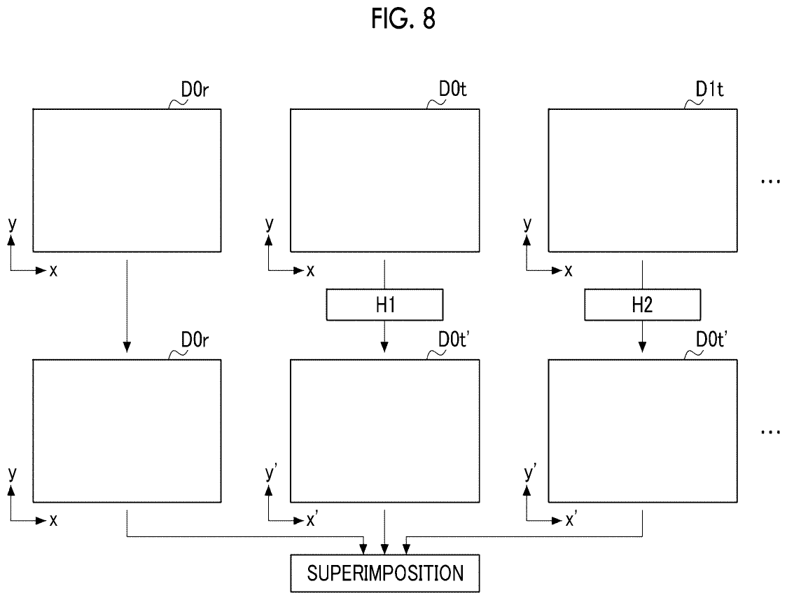

FIG. 8 describes the registration of the reference image D0r and the composite target image D0t. FIG. 8 shows a method of performing the registration of the reference image D0r and the plurality of composite target images D0t. A projective transformation matrix H1 shown in Equation (1) is applied to the first composite target image D0t to generate a composite target image D0t′ after the projective transformation. Similarly, a projective transformation matrix H2 shown in Equation (2) is applied to the second composite target image D0t to generate a composite target image D0t′ after the projective transformation. The same projective transformation processing is applied to the third and subsequent composite target images D0t′, and the registration is performed using each projective transformation matrix Hn. Here, N is an integer of 1 or more.

$$Expression 1$$

$$( \begin{matrix}{x}^{′} \\ {y}^{′} \\ w\end{matrix} ) = H 1 ( \begin{matrix}x \\ y \\ 1\end{matrix} ) \qquad ( 1 )$$

$$Expression 2$$

$$( \begin{matrix}{x}^{′} \\ {y}^{′} \\ w\end{matrix} ) = H 2 ( \begin{matrix}x \\ y \\ 1\end{matrix} ) \qquad ( 2 )$$

Here, the projective transformation matrix Hn is a 3×3 matrix, and changes original coordinates (x, y) into new coordinates (x′, y′). w is a normalization coefficient used to normalize the coordinates after the projective transformation.

The reference image D0r and each composite target image D0t′ after the projective transformation are subjected to registration by being superimposed on each other such that the coordinates match. However, as a result of applying the projective transformation, the coordinates of each pixel after the transformation are not integer values. Therefore, as shown in Equation (3) and Equation (4), it is desirable to perform appropriate registration by converting the coordinates into integer values. Here, round ( ) is a function that rounds a numerical value in parentheses to the nearest integer value.

$$Expression 3$$

$$x = round ( {x}^{′} ) \qquad ( 3 )$$

$$Expression 4$$

$$y = round ( {y}^{′} ) \qquad ( 4 )$$

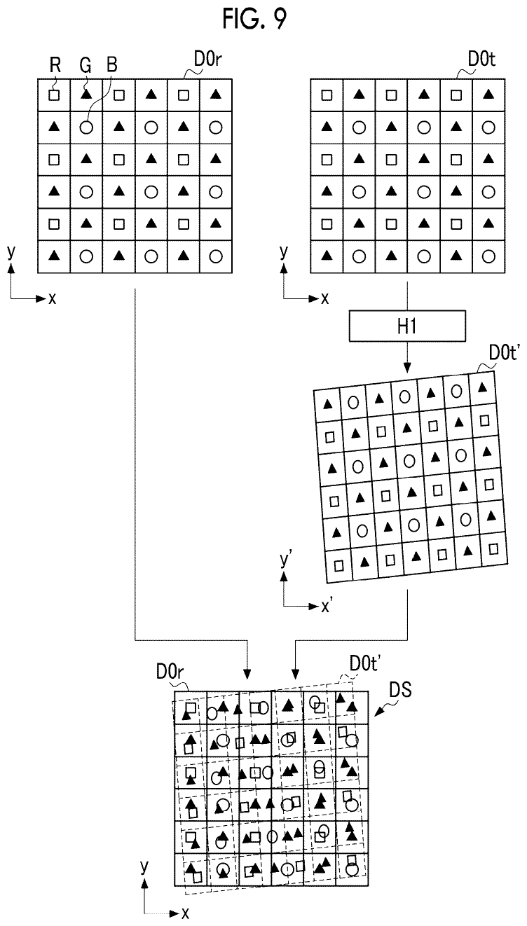

FIG. 9 specifically describes the registration of the reference image D0r and the composite target image D0t. In FIG. 9, a quadrangle indicates the R channel, a triangle indicates the G channel, and a circle indicates the B channel.

The reference image D0r and each composite target image D0t′ after the projective transformation are subjected to registration and superimposed on each other to generate a composite image DS. Each pixel of the composite image includes one or more channels (any one or a plurality of R, G, and B). The type and number of channels included in each pixel are different due to the result of the projective transformation, that is, the influence of the deviation due to the camera shake or the like.

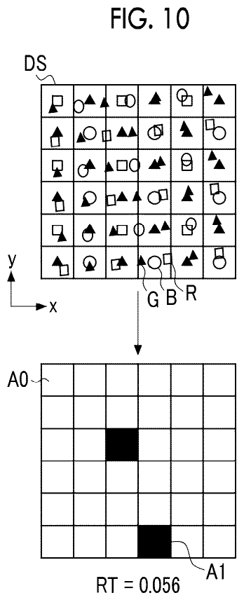

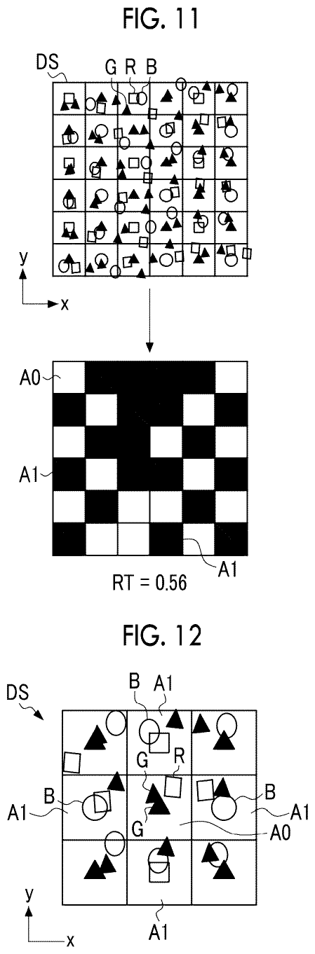

FIGS. 10 and 11 show calculation examples of the channel sufficiency ratio RT. FIG. 10 shows the channel sufficiency ratio RT in a case where the reference image D0r and one composite target image D0t′ after the projective transformation are subjected to registration. FIG. 11 shows the channel sufficiency ratio RT in a case where the reference image D0r and two composite target images D0t′ after the projective transformation are subjected to registration.

In FIGS. 10 and 11, A0 indicates a channel missing pixel in which the three channels are not aligned, and A1 indicates a full-channel pixel in which the three channels are aligned. In the examples shown in FIGS. 11 and 12, the number of pixels in the entire pixel region is 16. In the example shown in FIG. 10, since there are two full-channel pixels A1, RT=0.056 is calculated. In the example shown in FIG. 11, since there are 20 full-channel pixels A1, RT=0.56 is calculated.

As described above, the more the number of composite target images D0t to be combined with the reference image D0r, the higher the channel sufficiency ratio RT.

In addition, in a case where the channel sufficiency ratio RT is equal to or larger than the threshold value Rth and the pixel value of each pixel of the composite image DS is determined, the image composite processing unit 55 determines an interpolated value obtained by using peripheral values as the pixel value in a case where the channel missing pixel A0 is present. In addition, in a case where there are a plurality of the same channels in a case of determining the pixel value of each pixel of the composite image DS, the image composite processing unit 55 determines an average value as the pixel value. In a case where only one channel of the same type is present in the pixel, the image composite processing unit 55 determines a value of the channel as the pixel value.

For example, as shown in FIG. 12, since the channel missing pixel A0 positioned at the center is missing the B channel, an interpolated value obtained by using the values of the B channels of two pixels adjacent in the X direction and/or the values of the B channels of two pixels adjacent in the Y direction is determined as the pixel value of the B channel of the channel missing pixel A0. In addition, since there are two G channels in the channel missing pixel A0, an average value of the values of the G channels is calculated and determined as the pixel value of the G channel. A median value may be used instead of the average value.

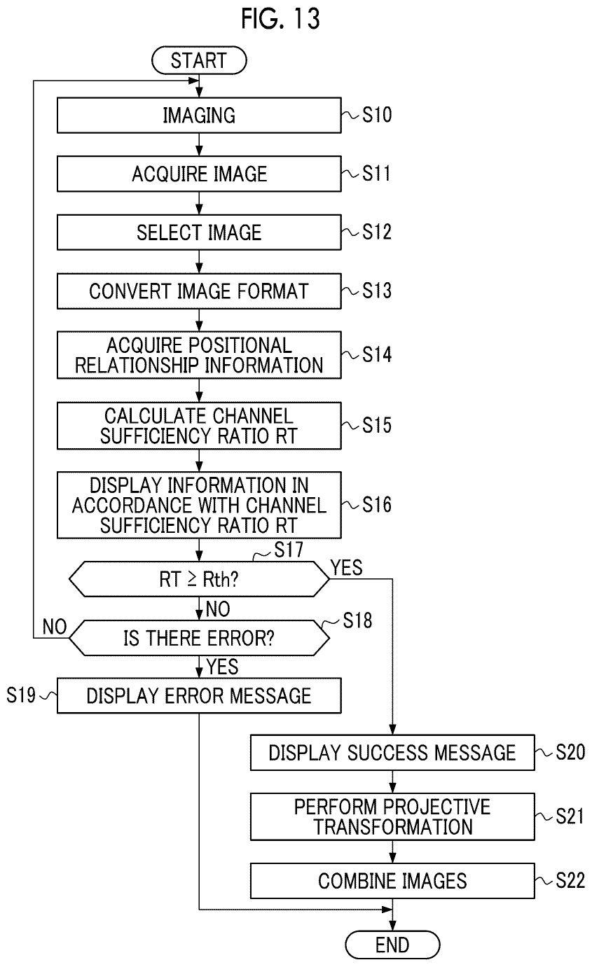

FIG. 13 shows a processing flow in the camera shake-utilizing multi-shot composite mode. First, the imaging controller 50 causes the imaging element 20 to perform the imaging operation in response to an imaging instruction made by the user operating the release button 14 (step S10). As a result, the continuous imaging is started. In this case, the imaging controller 50 stops the operation of the vibration-proof mechanism 43.

The imaging controller 50 acquires the Raw image D0 output from the imaging element 20 (step S11). In this case, the imaging controller 50 stores the acquired Raw image D0 in the RAM as a primary storage.

The image selection unit 51 selects the Raw image D0 acquired by the first imaging operation as the reference image D0r after receiving the imaging instruction (step S12). In the first loop, steps S13 to S18 are skipped, and the process returns to step S10 to perform the second imaging operation. Then, the image selection unit 51 selects the Raw image D0 acquired by the second imaging operation as the composite target image D0t.

Next, the image format conversion unit 52 converts the reference image D0r and the composite target image D0t in the Raw form into the images D1r and D it in the RGB form (step S13). Next, the positional relationship information acquisition unit 53 acquires the projective transformation matrix H1 as the positional relationship information between the reference image D0r and the composite target image D0t based on the images D1r and D1t (step S14).

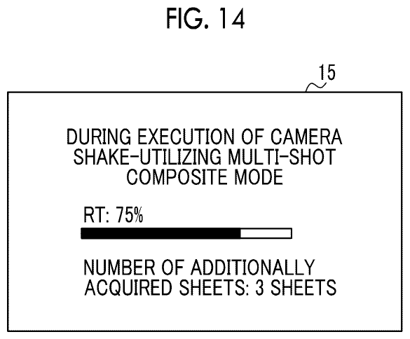

Next, the determination unit 54 calculates the channel sufficiency ratio RT in a case where the reference image D0r and the composite target image D0t are subjected to registration (step S15). Then, the determination unit 54 displays the information in accordance with the channel sufficiency ratio RT on the display 15 (step S16). For example, as shown in FIG. 14, the determination unit 54 displays the channel sufficiency ratio RT and the number of sheets of the composite target image D0t to be additionally acquired in order to reach the threshold value Rth of the channel sufficiency ratio RT.

In addition, the determination unit 54 determines whether or not the channel sufficiency ratio RT is equal to or larger than the threshold value Rth (step S17). In a case where the channel sufficiency ratio RT is smaller than the threshold value Rth (step S17: NO), the determination unit 54 determines whether or not there is an error on the positional relationship between the reference image D0r and the composite target image D0t (step S18).

For example, the determination unit 54 determines that an error has occurred in a case where the positional relationship is maintained in a constant state (that is, the channel sufficiency ratio RT does not increase for a certain time) by performing the continuous imaging in a state of being fixed by a tripod or the like. In addition, the determination unit 54 determines that an error has occurred in a case where the imaging element 20 has started the continuous imaging and a predetermined time has elapsed. In addition, the determination unit 54 may determine that an error has occurred in a case where the residual capacity of the RAM is equal to or less than a certain value by storing a certain number or more of Raw images D0 in the RAM as a primary storage.

In a case where the determination unit 54 determines that an error has occurred (step S18: YES), the determination unit 54 displays an error message on the display 15 (step S19). Thereafter, the imaging controller 50 ends the continuous imaging of the imaging element 20.

On the other hand, in a case where the determination unit 54 determines that an error has not occurred (step S18: NO), the process returns to step S10, and the imaging element 20 is caused to continue the imaging operation. The Raw image D0 obtained in this way is selected as the composite target image D0t by the image selection unit 51. The subsequent process is the same as the above-described process.

In a case where the channel sufficiency ratio RT reaches the threshold value Rth (step S17: YES), the determination unit 54 displays a success message on the display 15 (step S20). Thereafter, the image composite processing unit 55 performs the projective transformation on each of the selected one or more composite target images D0t (step S21), and combines the one or more composite target images D0t′ after the projective transformation and the reference image D0r to generate the composite image (that is, the super-resolution image) (step S22).

As described above, in the present embodiment, in the camera shake-utilizing multi-shot composite mode, the reference image and the composite target image are converted from the first form to the second-form images, the positional relationship information between the reference image and the composite target image is acquired from the second-form images, and the reference image and the composite target image are subjected to registration using the positional relationship information. In a case of the handheld imaging, in a case where a deviation of several pixels or more occurs between the images, the subject image is a multi-image in the composite image, and the image has a lot of noise. However, in the present embodiment, since the images are combined after appropriately performing the registration based on the acquired positional relationship information, it is possible to generate a high-accuracy super-resolution image with low noise even in the handheld continuous imaging.

In addition, in the present embodiment, in the camera shake-utilizing multi-shot composite mode, since the information on the imaging control is output in accordance with the ratio of the pixel region in which the three channels are aligned with respect to the entire pixel region, it is possible to efficiently generate a high-accuracy super-resolution image while reducing unnecessary imaging or processing.

### Modification Example

Hereinafter, various modification examples of the above embodiment will be described.

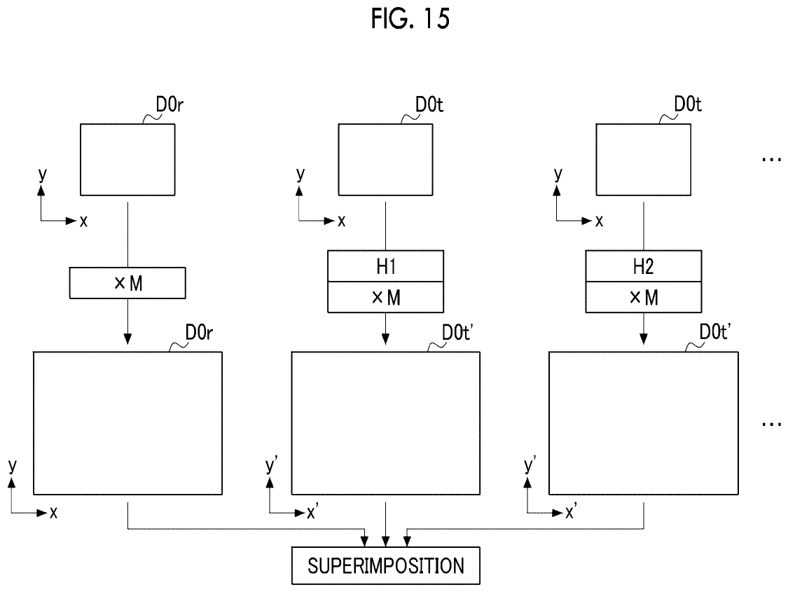

In the above-described embodiment, the reference image D0r and the composite target image D0t are combined without changing the resolution (that is, the total number of pixels in the image), but as shown in FIG. 15, the reference image D0r and the composite target image D0t may be combined after increasing the resolution of each of the reference image D0r and the composite target image D0t. Specifically, the resolution is increased by M times by increasing the lengths of the reference image D0r and the composite target image D0t in the x direction and the y direction by M times, respectively. In the example shown in FIG. 15, M=2. The user may be able to set the magnification M by operating the operating unit 42.

In a case where the coordinates of the composite target image D0t are converted into the integer values, the resolution can be increased by M times by using Equation (5) and Equation (6) instead of Equation (3) and Equation (4).

$$Expression 5$$

$$x = round ( {x}^{′} \times M ) \qquad ( 5 )$$

$$Expression 6$$

$$y = round ( {y}^{′} \times M ) \qquad ( 6 )$$

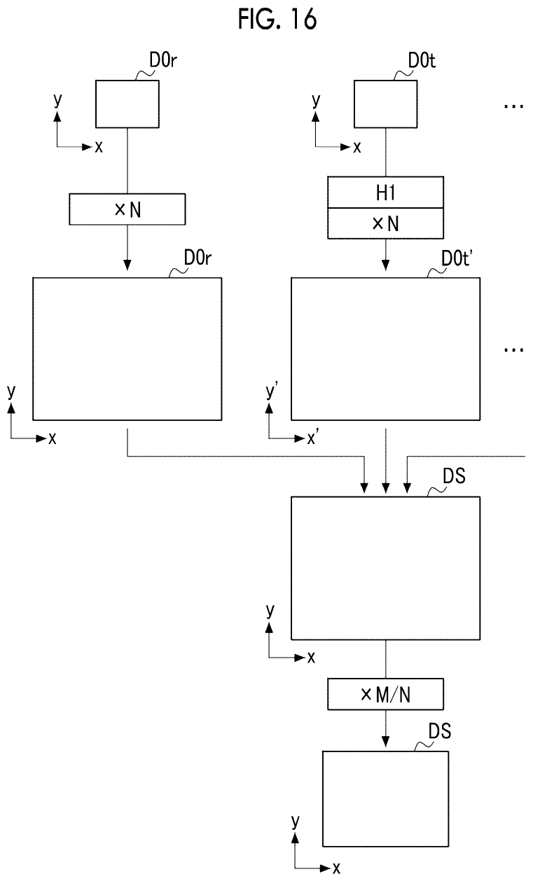

In addition, the composite image may be generated by increasing the resolution of the reference image D0r and the composite target image D0t to a resolution higher than a specific resolution, and the resolution of the composite image may be decreased to the specific resolution. Specifically, as shown in FIG. 16, the resolution of the composite image DS is increased to M times the initial resolution by combining the reference image D0r and the composite target image D0t at a resolution that is N times the resolution of each of the reference image D0r and the composite target image D0t and setting the resolution of the composite image DS to M/N times the resolution. Here, M<N. In the example shown in FIG. 16, N=3 and M=2.

In a case where the images are combined, moire or ghost, which is a composite-specific artifact, may occur. However, in the present disclosure, the composite image having a resolution higher than the desired resolution is generated, and the composite image is reduced in resolution, so that the artifact can be reduced. This is because, in a case where the image combined at the high resolution is reduced in resolution (down-sampled), the image is smoothed.

In addition, in the above-described embodiment, the determination unit 54 calculates the channel sufficiency ratio RT based on the positional relationship information before the image composite processing unit 55 executes the image composite of the reference image D0r and the composite target image D0t. Instead of this, the determination unit 54 may calculate the channel sufficiency ratio RT in a case where the image composite processing unit 55 executes the image composite or after the image composite is executed.

In addition, in the above-described embodiment, the image selection unit 51 selects the Raw image D0 acquired first as the reference image D0r after the continuous imaging is started. This is because the Raw image D0 acquired first is an image closest to the composition intended by the user, and thus is appropriate as the reference image D0r. With this configuration, the image composite can be performed based on the composition intended by the user, and the quality of the final composite image can be improved.

Instead of this, the image selection unit 51 may be configured to select the Raw image DO having the highest channel sufficiency ratio RT from among the plurality of Raw images D0 acquired by the continuous imaging as the reference image D0r. In this case, each time a new Raw image D0 is acquired, each Raw image D0 is assumed as the reference image D0r, and the channel sufficiency ratio RT is calculated. Then, by selecting the Raw image D0 having the highest channel sufficiency ratio RT as the reference image D0r, the image composite using the optimal reference image D0r can be realized. With this configuration, the selection accuracy of the reference image D0r is improved, and the registration and the combining can be performed based on a more appropriate Raw image D0, so that the quality of the composite image DS is further improved.

In addition, in the above-described embodiment, the entire pixel region of the reference image D0r and the composite target image D0t is combined, but a part of the entire pixel region may be cropped and combined. As a result, the number of pixels to be processed is reduced, and the image composite can be accelerated. The user may be able to set the cropping magnification by operating the operating unit 42.

In the above-described embodiment, the “camera shake-utilizing multi-shot composite mode” of changing the relative position between the subject image and the imaging element 20 by using the shake applied to the imaging apparatus 10 due to the camera shake of the user or the like can be executed. In addition, the “pixel-shifting multi-shot composite mode” of changing the relative position between the subject image and the imaging element 20 a plurality of times by actively moving the imaging element 20 by the vibration-proof mechanism 43 may be executed.

In the pixel-shifting multi-shot composite mode, the processor 40 causes the imaging element 20 to perform the imaging a plurality of times while moving the imaging element 20 in a direction orthogonal to the optical axis in a fine manner. In addition, the processor 40 generates the super-resolution image by combining the plurality of images acquired by the imaging element 20. The pixel-shifting multi-shot composite mode is known in JP2016-171511A, JP2019-161564A, and the like.

In the pixel-shifting multi-shot composite mode, it is preferable that the imaging apparatus 10 is used in a state of being fixed on a tripod or the like because it is not preferable that a shake is applied to the imaging apparatus 10 due to a camera shake of the user or the like.

In the above-described embodiment, the determination unit 54 may switch to the pixel-shifting multi-shot composite mode in a case where it is determined that an error has occurred during the execution of the camera shake-utilizing multi-shot composite mode. As a result, an appropriate mode is selected according to the imaging environment, and the super-resolution image can be stably acquired.

In addition, in the above-described embodiment, the processor 40 displays the message on the display 15, but may display the message on the finder 17 instead of the display 15 or in addition to the display 15.

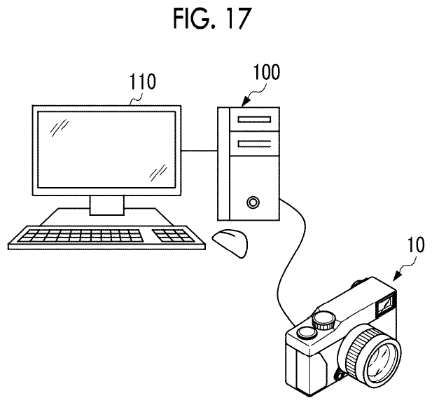

In addition, as shown in FIG. 17, the imaging apparatus 10 may be able to perform tethered imaging in which imaging is performed in a wired or wirelessly connected state to a personal computer 100. In this case, the above-described registration processing, combining processing, and the like may be performed in the personal computer 100. In addition, the above-described message display may be performed on a display 110 provided in the personal computer 100. The imaging apparatus 10 may be connectable to an external apparatus other than the personal computer 100.

In the above-described embodiment, each process executed by the processor 40 is executed by any computer. Moreover, any computer may execute these processes by a processor as hardware, a program as software, or a combination thereof. In such a case, the processor is configured to execute various types of processing in the above-described embodiment in cooperation with the program, and may function as each unit or each means in the above-described embodiment. Further, the execution order of the processing by the processor is not limited to the above-described order and may be changed as appropriate. Any computer may be a general-purpose computer, a computer for a specific application, a workstation, or another system capable of executing each process.

The processor may be composed of one or a plurality of pieces of hardware, and types of hardware are not limited. The processor may be configured by, for example, a CPU, a micro processing unit (MPU), a programmable logic device such as a field programmable gate array (FPGA), a dedicated circuit for executing specific processing, such as an application specific integrated circuit (ASIC), or hardware such as a graphic processing unit (GPU) or a neural processing unit (NPU). Types of hardware may be a combination of different types of hardware. In a case where the plurality of types of hardware are configured to execute one or a plurality of types of processing of a certain processor, the plurality of types of hardware may exist in devices physically separated from each other or may exist in the same device. Further, in any of the embodiments, the order of each processing performed by the processor is not limited to the above-described order, and may be changed as appropriate. The hardware is configured by an electric circuit (circuitry) in which circuit elements, such as semiconductor elements, are combined, or the like.

Further, the program may be software, such as firmware or a microcode. Furthermore, the program may be, for example, a program module group, and each function thereof may be implemented by a processor configured to execute each function. The program may be a program code or a plurality of code segments stored in one or a plurality of non-transitory computer-readable media (for example, a storage medium and other storages). The program may be stored in the plurality of non-transitory computer-readable media existing in physically separated devices. The program code or the code segment may represent any combination of procedures, functions, subprograms, routines, subroutines, modules, software packages, classes, instructions, data structures, or program statements. The program code or the code segment may be connected to another code segment or a hardware circuit by transmitting and receiving information, data, an argument, a parameter, or contents of a memory.

In addition, in the above-described embodiment, the program 45A is described as being stored in the memory 45 in advance, but the present disclosure is not limited to this. The program 45A may be provided in a form of being recorded on a recording medium, such as a compact disc read only memory (CD-ROM), a digital versatile disc read only memory (DVD-ROM), and a universal serial bus (USB) memory. In addition, the program 45A may be downloaded from an external device via a network.

The technology of the present disclosure extends to any program products. The program products include products in any aspect for providing a program. For example, the program product includes a program provided through a network such as the Internet, a non-transitory computer-readable recording medium, such as a CD-ROM, a DVD, and a USB memory in which the program is stored, and the like.

It is possible to understand the technology according to the following supplementary notes, based on the above description.

### Supplementary Note 1

An image processing system comprising: a processor,
wherein the processor is configured to:
   acquire a plurality of first-form images in which each pixel is any one of three channels;
   select one image among the plurality of first-form images as a reference image and one or more other images as composite target images;
   convert the reference image and the composite target image from the first-form image to a second-form image;
   acquire information on a positional relationship between the reference image and the composite target image based on the second-form image;
   perform registration between the reference image and the composite target image in a first form based on the information on the positional relationship; and
   output information on imaging control in accordance with a ratio of a pixel region, in which the three channels are aligned, to an entire pixel region.

### Supplementary Note 2

The image processing system according to Supplementary Note 1,
wherein the processor is configured to:
   generate a composite image obtained by combining the reference image and the composite target image by using the information on the positional relationship; and
   output the information on the imaging control in accordance with the ratio.

### Supplementary Note 3

The image processing system according to Supplementary Note 1 or 2,
wherein the imaging control is control related to determination of a necessary number of sheets of the composite target images.

### Supplementary Note 4

The image processing system according to any one of Supplementary Notes 1 to 3,
wherein the imaging control is control of additionally acquiring the composite target image.

### Supplementary Note 5

The image processing system according to any one of Supplementary Notes 1 to 3,
wherein the imaging control is control of displaying the information in accordance with the ratio on a display device.

### Supplementary Note 6

The image processing system according to Supplementary Note 5,
wherein the information is information on the number of sheets of the composite target images to be additionally acquired.

### Supplementary Note 7

The image processing system according to any one of Supplementary Notes 1 to 6, further comprising:
a vibration-proof mechanism,
wherein the processor is configured to restrict an operation of the vibration-proof mechanism in a case where an imaging element performs an imaging operation.

### Supplementary Note 8

The image processing system according to any one of Supplementary Notes 1 to 7,
wherein the first form is a Raw form, and the second form is an RGB form.

### Supplementary Note 9

The image processing system according to any one of Supplementary Notes 1 to 8,
wherein the processor is configured to generate a composite image by performing projective transformation on the composite target image using the information on the positional relationship, and then combining the reference image and the composite target image.

### Supplementary Note 10

The image processing system according to Supplementary Note 9,
wherein the processor is configured to generate the composite image by increasing a resolution of the reference image and the composite target image and then combining the reference image and the composite target image.

### Supplementary Note 11

The image processing system according to Supplementary Note 9 or 10,
wherein the processor is configured to generate the composite image by increasing the resolution of the reference image and the composite target image to a resolution higher than a specific resolution, and decrease the resolution of the composite image to the specific resolution.

### Supplementary Note 12

The image processing system according to any one of Supplementary Notes 9 to 11,
wherein the processor is configured to determine, when a pixel value of each pixel of the composite image is determined, an average value as the pixel value in a case where a plurality of the same channels are present.

### Supplementary Note 13

The image processing system according to any one of Supplementary Notes 9 to 12,
wherein the processor is configured to determine, when a pixel value of each pixel of the composite image is determined, an interpolated value obtained by using peripheral values as the pixel value in a case where a missing channel is present.

### Supplementary Note 14

The image processing system according to any one of Supplementary Notes 1 to 13,
wherein the processor is configured to:
   calculate the positional relationship and the ratio while an imaging element is allowed to perform continuous imaging; and
   end the continuous imaging in a case where the ratio reaches a threshold value or more, in a case where the positional relationship is maintained in a constant state, or in a case where a predetermined time is reached.

### Supplementary Note 15

The image processing system according to any one of Supplementary Notes 1 to 14,
wherein the processor is configured to acquire the plurality of first-form images in a continuous manner, and select a first image as the reference image.

### Supplementary Note 16

The image processing system according to any one of Supplementary Notes 1 to 14,
wherein the processor is configured to select an image having a highest ratio among the plurality of first-form images as the reference image.

What is claimed is:

1. An image processing system comprising: a processor,
wherein the processor is configured to:
acquire a plurality of first-form images in which each pixel is any one of three channels;
select one image among the plurality of first-form images as a reference image and one or more other images, each of the one or more other images being a composite target image;
convert the reference image and the composite target image from the first-form image to a second-form image;
acquire information on a positional relationship between the reference image and the composite target image based on the second-form image;
perform registration between the reference image and the composite target image in a first form based on the information on the positional relationship; and
output information on imaging control in accordance with a ratio of a pixel region, in which the three channels are aligned, to an entire pixel region.

2. The image processing system according to claim 1,
wherein the processor is configured to:
generate a composite image obtained by combining the reference image and the composite target image by using the information on the positional relationship; and
output the information on the imaging control in accordance with the ratio.

3. The image processing system according to claim 1,
wherein the imaging control is control related to determination of a necessary number of sheets for the composite target image.

4. The image processing system according to claim 1,
wherein the imaging control is control of additionally acquiring the composite target image.

5. The image processing system according to claim 1,
wherein the imaging control is control of displaying the information in accordance with the ratio on a display device.

6. The image processing system according to claim 5,
wherein the information is information on the number of sheets to be additionally acquired for the composite target image.

7. The image processing system according to claim 1, further comprising:
a vibration-proof mechanism,
wherein the processor is configured to restrict an operation of the vibration-proof mechanism in a case where an imaging element performs an imaging operation.

8. The image processing system according to claim 1,
wherein the first form is a Raw form, and the second form is an RGB form.

9. The image processing system according to claim 1,
wherein the processor is configured to generate a composite image by performing projective transformation on the composite target image using the information on the positional relationship, and then combining the reference image and the composite target image.

10. The image processing system according to claim 9,
wherein the processor is configured to generate the composite image by increasing a resolution of the reference image and the composite target image and then combining the reference image and the composite target image.

11. The image processing system according to claim 9,
wherein the processor is configured to generate the composite image by increasing the resolution of the reference image and the composite target image to a resolution higher than a specific resolution, and decrease the resolution of the composite image to the specific resolution.

12. The image processing system according to claim 9,
wherein the processor is configured to determine, when a pixel value of each pixel of the composite image is determined, an average value as the pixel value in a case where a plurality of the same channels are present.

13. The image processing system according to claim 9,
wherein the processor is configured to determine, when a pixel value of each pixel of the composite image is determined, an interpolated value obtained by using peripheral values as the pixel value in a case where a missing channel is present.

14. The image processing system according to claim 1,
wherein the processor is configured to:
calculate the positional relationship and the ratio while an imaging element is allowed to perform continuous imaging; and
end the continuous imaging in a case where the ratio reaches a threshold value or more, in a case where the positional relationship is maintained in a constant state, or in a case where a predetermined time is reached.

15. The image processing system according to claim 1,
wherein the processor is configured to acquire the plurality of first-form images in a continuous manner, and select a first image as the reference image.

16. The image processing system according to claim 1,
wherein the processor is configured to select an image having a highest ratio among the plurality of first-form images as the reference image.

17. A control method of an image processing system including a processor, the control method comprising:
via the processor,
acquiring a plurality of first-form images in which each pixel is any one of three channels;
selecting one image among the plurality of first-form images as a reference image and one or more other images, each of the one or more other images being a composite target image;
converting the reference image and the composite target image from the first-form image to a second-form image;
acquiring information on a positional relationship between the reference image and the composite target image based on the second-form image;
performing registration between the reference image and the composite target image in a first form based on the information on the positional relationship; and
outputting information on imaging control in accordance with a ratio of a pixel region, in which the three channels are aligned, to an entire pixel region.

18. A non-transitory computer-readable storage medium storing a program that operates an image processing system including a processor, the program causing the processor to execute a process comprising:
acquiring a plurality of first-form images in which each pixel is any one of three channels;
selecting one image among the plurality of first-form images as a reference image and one or more other images, each of the one or more other images being a composite target image;
converting the reference image and the composite target image from the first-form image to a second-form image;
acquiring information on a positional relationship between the reference image and the composite target image based on the second-form image;
performing registration between the reference image and the composite target image in a first form based on the information on the positional relationship; and
outputting information on imaging control in accordance with a ratio of a pixel region, in which the three channels are aligned, to an entire pixel region.
